(19) United States
(12) Patent Application Publication
(10) Pub. No.: US 2023/0116768 A1
(43) Pub. Date: Apr. 13, 2023

(54) LATENCY MANAGEMENT SYSTEM FOR ADAPTIVE SWITCHING BETWEEN ACTIVE WI-FI NETWORKS FROM A COMMON RADIO PLATFORM

(71) Applicant: ARRIS Enterprises LLC, Suwanee, GA (US)

(72) Inventor: Ian G. WHEELOCK, Cork (IE)

(21) Appl. No.: 17/955,998

(22) Filed: Sep. 29, 2022

Related U.S. Application Data
(60) Provisional application No. 63/254,726, filed on Oct. 12, 2021.

(51) Int. Cl. H04W 72/04

(52) U.S. Cl. CPC H04W 72/0493

(57) ABSTRACT

A network device for use with a first client device and a second client device, said client device comprising: a memory; a radio; a control interface; and a processor configured to execute instructions stored on said memory to cause said network device to: determine a portion of time for a first channel state; determine a portion of time for a second channel state; instruct said radio system to operate in the first channel state; monitor a first client device parameter; instruct said radio system to operate in the second channel state; monitor a second client device parameter; modify the initial first portion of time; generate the control signal to place said radio system in the first channel state based on the modified initial first portion of time; and transmit the control signal to said radio system via said control interface to place said radio system in the first channel state.

### BACKGROUND

Embodiments of the invention relate to operating a network device on several frequency bands.

### SUMMARY

Aspects of the present invention are drawn to a network device for use with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel. The client device includes: a memory; a radio system controllably configured to operate in a first channel state or a second channel state, the first channel state enabling transmission of the first client device reception data on the first channel and reception of the first client device transmission data on the first channel, the second channel state enabling transmission of the second client device reception data on the second channel and reception of the second client device transmission data on the second channel; a control interface arranged to provide a control signal to the radio system so as to place the radio system in either the first channel state or the second channel state; and a processor configured to execute instructions stored on the memory to cause the network device to: determine an initial first portion of time for which the radio system should be configured to operate in the first channel state; determine an initial second portion of time for which the radio system should be configured to operate in the second channel state; instruct the radio system to operate in the first channel state for the initial first portion of time; monitor a first client device parameter associated with the first client device during the first portion of time; instruct the radio system to operate in the second channel state for the initial second portion of time; monitor a second client device parameter associated with the second client device during the second portion of time; modify the initial first portion of time based on at least one of the monitored first client device parameter and the monitored second client device parameter; generate the control signal to place the radio system in the first channel state for a subsequent portion of time based on the modified initial first portion of time; and transmit the control signal to the radio system via the control interface to place the radio system in the first channel state.

In some embodiments, the processor is configured to execute instructions stored on the memory to additionally cause the network device to: modify the initial second portion of time based on at least one of the monitored first client device parameter and the monitored second client device parameter; generate a second control signal to place the radio system in the second channel state for a second subsequent portion of time based on the modified initial second portion of time; and transmit the second control signal to the radio system via the control interface to place the radio system in the second channel state.

In some further embodiments, the processor is configured to execute instructions stored on the memory to additionally cause the network device to generate the second control signal to modify a duty cycle between the first channel state and the second channel state.

In some of these embodiments, the processor is configured to execute instructions stored on the memory to additionally cause the network device to generate the second control signal to modify a frequency of changing between the first channel state and the second channel state.

In some embodiments, the radio system is configured to operate in a first GHz band in the first state and to operate in a second GHz band in the second state.

In some further embodiments, the radio system is further configured to operate in a third GHz band while operating in the first state or the second state.

Other aspects of the present disclosure are drawn to a method of using a network device with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel. The method includes: determining, via a processor configured to execute instructions stored on a memory, an initial first portion of time for which the radio system should be configured to operate in the first channel state; determining, via the processor, an initial second portion of time for which the radio system should be configured to operate in the second channel state; instructing, via the processor, the radio system to operate in the first channel state for the initial first portion of time; monitoring, via the processor, a first client device parameter associated with the first client device during the initial first portion of time; instructing, via the processor, the radio system to operate in the second channel state for the initial second portion of time; monitoring, via the processor, a second client device parameter associated with the second client device during the initial second portion of time; modifying, via the processor, the initial first portion of time based on at least one of the monitored first client device parameter and the monitored second client device parameter; generating, via the processor, the control signal to place the radio system in the first channel state for a subsequent portion of time based on the modified initial first portion of time; and transmitting, via the processor, the control signal to the radio system via the control interface to place the radio system in the first channel state.

In some embodiments, the method further includes: modifying, via the processor, the initial second portion of time based on at least one of the monitored first client device parameter and the monitored second client device parameter; generating, via the processor, a second control signal to place the radio system in the second channel state for a second subsequent portion of time based on the modified initial second portion of time; and transmitting, via the processor, the second control signal to the radio system via the control interface to place the radio system in the second channel state.

In some further embodiments, the method further includes generating, via the processor, the second control signal to modify a duty cycle between the first channel state and the second channel state.

In some of these embodiments, the method further includes generating, via the processor, the second control signal to modify a frequency of changing between the first channel state and the second channel state.

In some embodiments, the radio system is configured to operate in a first GHz band in the first state and to operate in a second GHz band in the second state.

In some of these embodiments, the method further includes operating the radio system in a third GHz band while operating in the first state or the second state.

Other aspects of the present disclosure are drawn to a non-transitory, computer-readable media having computer-readable instructions stored thereon, the computer-readable instructions being capable of being read by a network device for use with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel. The computer-readable instructions are capable of instructing the client device to perform the method including: determining, via a processor configured to execute instructions stored on a memory, an initial first portion of time for which the radio system should be configured to operate in the first channel state; determining, via the processor, an initial second portion of time for which the radio system should be configured to operate in the second channel state; instructing, via the processor, the radio system to operate in the first channel state for the initial first portion of time; monitoring, via the processor, a first client device parameter associated with the first client device during the initial first portion of time; instructing, via the processor, the radio system to operate in the second channel state for the initial second portion of time; monitoring, via the processor, a second client device parameter associated with the second client device during the initial second portion of time; modifying, via the processor, the initial first portion of time based on at least one of the monitored first client device parameter and the monitored second client device parameter; generating, via the processor, the control signal to place the radio system in the first channel state for a subsequent portion of time based on the modified initial first portion of time; and transmitting, via the processor, the control signal to the radio system via the control interface to place the radio system in the first channel state.

In some embodiments, the computer-readable instructions are capable of instructing the client device to perform the method further includes: modifying, via the processor, the initial second portion of time based on at least one of the monitored first client device parameter and the monitored second client device parameter; generating, via the processor, a second control signal to place the radio system in the second channel state for a second subsequent portion of time based on the modified initial second portion of time; and transmitting, via the processor, the second control signal to the radio system via the control interface to place the radio system in the second channel state.

In some further embodiments, the computer-readable instructions are capable of instructing the client device to perform the method further includes generating, via the processor, the second control signal to modify a duty cycle between the first channel state and the second channel state.

In some of these embodiments, the computer-readable instructions are capable of instructing the client device to perform the method further includes generating, via the processor, the second control signal to modify a frequency of changing between the first channel state and the second channel state.

In some embodiments, the computer-readable instructions are capable of instructing the client device to perform the method wherein the radio system is configured to operate in a first GHz band in the first state and to operate in a second GHz band in the second state.

In some of these embodiments, the computer-readable instructions are capable of instructing the client device to perform the method further includes operating the radio system in a third GHz band while operating in the first state or the second state.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a communication system;

FIG. 2 illustrates a prior-art network device connected to client devices;

FIG. 3 illustrates a network device connected to client devices in accordance with aspects of the present disclosure;

FIG. 4 illustrates an algorithm for allocating data between two bands on a single radio in accordance with aspects of the present disclosure;

FIG. 5A illustrates a sample embodiment of a time period for which data is transmitted over several radio frequency bands, in accordance with aspects of the present disclosure;

FIG. 5B illustrates a sample embodiment of a time period for which data is transmitted over several radio frequency bands, in accordance with aspects of the present disclosure;

FIG. 5C illustrates a sample embodiment of a time period for which data is transmitted over several radio frequency bands, in accordance with aspects of the present disclosure;

FIG. 5D illustrates a sample embodiment of a time period for which data is transmitted over several radio frequency bands, in accordance with aspects of the present disclosure;

FIG. 6 illustrates an exploded view of a network device that communicates with multiple client devices in accordance with aspects of the present disclosure; and

FIG. 7 illustrates an exploded view of a radio subsystem of the network device, in accordance with aspects of the present disclosure.

### DETAILED DESCRIPTION

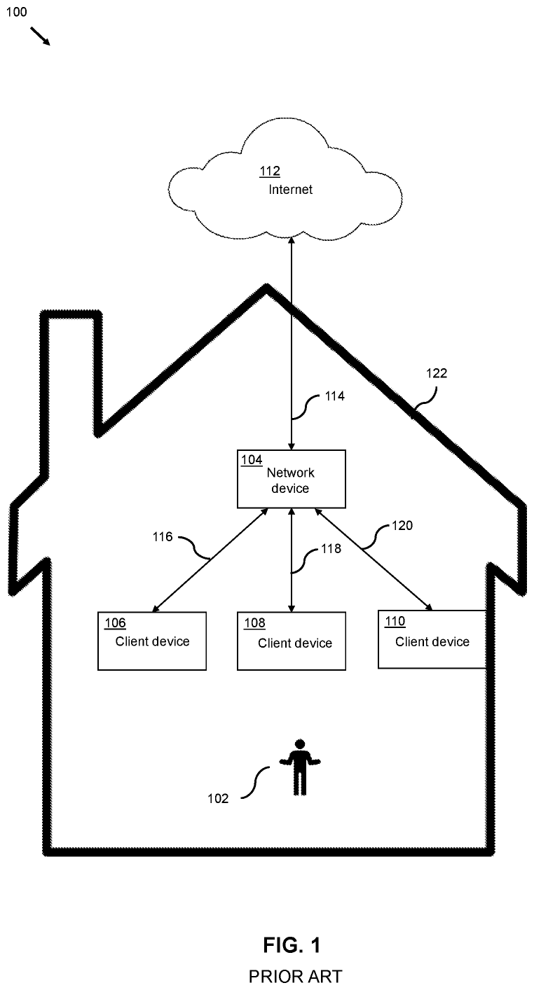

FIG. 1 illustrates a communication system 100.

As shown in the figure, communication system 100 includes a user 102, a prior-art network device 104, client devices 106, 108, and 110, an Internet 112, channels 114, 116, 118, and 120, and a residence 122. User 102, prior-art network device 104, and client devices 106, 108, and 110 are disposed at residence 122.

Prior-art network device 104 is arranged to communicate with client device 106 by channel 116. Prior-art network device 104 is arranged to communicate with client device 108 by channel 118. Prior-art network device 104 is arranged to communicate with client device 110 by channel 120. Prior-art network device 104 is arranged to communicate with Internet 112 by channel 114.

Prior art network device 104 may be any device or system that operates to allow data to flow from one discrete device or network to another. Prior art network device 104 may perform such functions as Web acceleration and HTTP compression, flow control, encryption, redundancy switchovers, traffic restriction policy enforcement, data compression, TCP performance enhancements (e.g., TCP spoofing), quality of service functions (e.g., classification, prioritization, differentiation, random early detection, TCP/UDP flow control), bandwidth usage policing, dynamic load balancing, address translation, and routing. In this non-limiting example, prior art network device 104 may be a router, a gateway, an access point, an extender, or a mesh network device.

Client devices 106, 108, and 110 may be any devices or systems that present content to, accept inputs from, or directly or indirectly interact with user 102. In this non-limiting example, client devices 106, 108, and 110 may be smart phones, tablets, personal computers, TV set-top boxes, videogame consoles, smart media devices, home security devices, or Internet-of-Things (IoT) devices.

Internet 112 is a global set of interconnected computing resources and networks.

Channel 114 may be any device or system that facilitates communications between devices or networks. Channel 114 may include physical media or wiring, such as coaxial cable, optical fiber, or digital subscriber line (DSL); or wireless links, such as Wi-Fi, LTE, satellite, or terrestrial radio links; or a combination of any of these examples or their equivalents. The term “Wi-Fi” as used herein may be considered to refer to any of Wi-Fi 4, 5, 6, 6E, or any variation thereof. The data communicated on such networks can be implemented using a variety of protocols on a network such as a WAN, a virtual private network (VPN), a metropolitan area network (MAN), a system area network (SAN), a DOCSIS network, a fiber optics network (including fiber-to-the-home, fiber-to-the-X, or hybrid fiber-coax), a digital subscriber line (DSL), a public switched data network (PSDN), a global Telex network, or a 2G, 3G, 4G or 5G, for example. Though channel 114 is shown as a single link, it is contemplated that channel 114 may contain multiple links and devices, including access points, routers, gateways, and servers.

Channels 116, 118, and 120 may be any devices or systems that facilitate wireless communications between prior art network device 104 and client devices 106, 108, and 110 respectively. In this non-limiting example, channels 116, 118, and 120 are Wi-Fi bands.

In normal operation, prior art network device 104 enables data communications between Internet 112, client device 106, client device 108, and client device 110. User 102 may interact with client devices 106, 108, and 110 at various times and interaction levels. For purposes of discussion, suppose that user 102 is watching a streaming video on client device 106, which requires a large amount of data bandwidth. Suppose that user 102 then stops watching video and starts browsing the Web on client device 108. In this case, bandwidth requirements are modest. Finally, suppose that client device 110 is a security camera that records video to a service based in Internet 112. The low resolution of typical security video means that bandwidth requirements of client device 110 are modest, but constant.

In this non-limiting example, client device 106 communicates to prior art network device 104 over channel 116 using a 5 GHz Wi-Fi band. Client device 108 communicates to prior art network device 104 over channel 118 using a 6 GHz Wi-Fi band. Client device 110 communicates to prior art network device 104 over channel 120 using a 2.4 GHz Wi-Fi band.

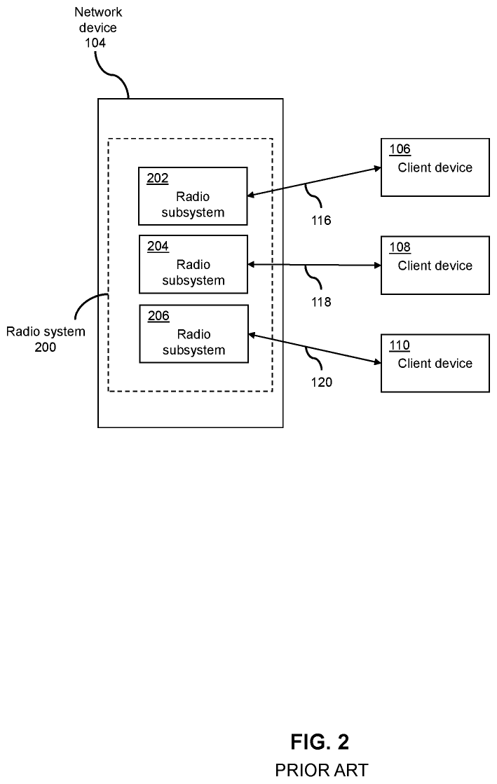

FIG. 1 illustrates communication system 100 including prior art network device 104 and client devices 106, 108, and 110. Aspects of prior art network device 104 communicating with client devices 106, 108, and 110 will now be discussed with reference to FIG. 2.

FIG. 2 illustrates prior-art network device 104 connected to client devices 106, 108, and 110.

As shown in the figure, network device 104 includes radio system 200. Radio system 200 includes radio subsystems 202, 204, and 206. Radio subsystem 202 is arranged to communicate with client device 106 by channel 116. Radio subsystem 204 is arranged to communicate with client device 108 by channel 118. Radio subsystem 206 is arranged to communicate with client device 110 by channel 120.

Referring to the example given in FIG. 1, suppose that channel 116 operates within a 5 GHz band, channel 118 operates within a 6 GHz band, and channel 120 operates within a 2.4 GHz band. In this prior-art example, radio subsystem 202 is utilized specifically to service channel 116 within the 5 GHz band; radio subsystem 204 is utilized specifically to service channel 118 within the 6 GHz band; and radio subsystem 206 is utilized specifically to service channel 120 within the 2.4 GHz band.

FIG. 2 illustrates prior-art network device 104, which utilizes three radio subsystems to operate on three bands. Prior-art network device 104 will therefore have an increased cost as attributed to the multiple different radio subsystems that are required to support the 2.4 GHz, 5 GHz and 6 GHz bands. Further, for some users, this increased cost may not be justified as their home may not include client devices that support the 6 GHz band, wherein the radio subsystem providing the 6 GHz band is not being used. Further, in the future, for other users, this increased cost may not be justified as their home may no longer include client devices that support the 5 GHz band, wherein the radio subsystem providing the 5 GHz band will no longer be used.

In home networks and workplaces, many client devices are connected to the Internet wirelessly. Many of these client devices operate on Wi-Fi 2.4 GHz and 5 GHz bands, with some client devices operating on the newer 6 GHz band. However, as the 6 GHz band is newer to the market, there are many client devices which are not able to operate on the 6 GHz band. Even so, many manufacturers will create network devices with 3 radios: 2.4 GHz radio; 5 GHz radio; and 6 GHz radio. Manufacturing network devices with 3 radios will cost more to the manufactures, and consumers will spend more to purchase these network devices. As many client devices are unable to operate on a 6 GHz band yet, these can be wasteful to both parties.

What is needed is a system and method for supporting 2.4, 5, and 6 GHz bands in a network device while minimizing manufacturing costs and lowering consumer spending.

A system and method in accordance with the present disclosure supports 2.4, 5, and 6 GHz bands in a network device while minimizing manufacturing costs and lowering consumer spending.

In accordance with the present disclosure, a network device is used with multiple client devices. The network device has two radios; one operates on a 2.4 GHz channel, and the other operates on both a 5 GHz and 6 GHz channel. The dual-band radio system transmits/receives data to/from client devices over the first band for a period of time, then changes state in order to transmits/receives data to/from client devices over the second band for a period of time. The network device will analyze client device parameters of the associated client devices and alter the periods for both the first band and the second band to maintain or even optimize a quality of service for client devices on both the first band and the second band.

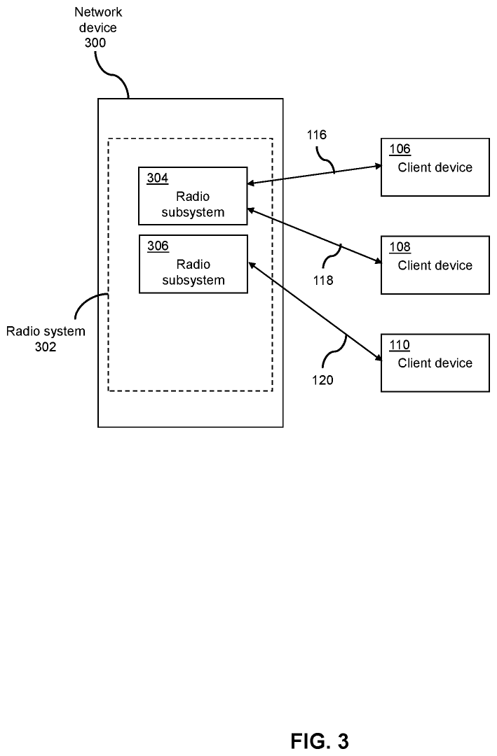

An example system and method for operating a network device over two frequency bands in accordance with aspects of the present disclosure will now be described in greater detail with reference to FIGS. 3-7.

FIG. 3 illustrates a network device 300 that connected to client devices 106, 108, and 110, in accordance with aspects of the present disclosure. For purposes of discussion, network device 300 would replace prior art network device 104 within residence 122.

As shown in the figure, network device 300 includes a radio system 302. Radio system 302 includes radio subsystems 304 and 306. In this non-limiting example embodiment, radio system 302 includes one or more antennas and communicates wirelessly via one or more of the 2.4 GHz band, the 5 GHz band, the 6 GHz band, and the 60 GHz band, or at the appropriate band and bandwidth to implement any IEEE 802.11 Wi-Fi protocols, such as the Wi-Fi 4, 5, 6, or 6E protocols. It should be noted that a radio system in accordance with aspects of the present disclosure may operate in any number of different bands.

Radio subsystem 304 is arranged to communicate with client device 106 by channel 116 and with client device 108 by channel 118. This can be done by any method, a non-limiting example of which is disclosed in U.S. patent application Ser. No. 17/337,785 (the ′785 application), filed on Jun. 3, 2021, the entire disclosure of which is incorporated herein by reference.

Radio subsystem 306 is arranged to communicate with client device 110 by channel 120.

In operation, radio subsystem 304 switches between operating on channel 116 during one time segment and channel 118 at another time segment. The goal of a system in accordance with the present disclosure is to maintain a minimum quality of service (QoS), or even maximize a QoS, for client devices associated with radio subsystem 304 on channel 116 and for client devices associated with radio subsystem 304 on channel 118. This goal is not mentioned, let alone addressed, in the '785 application. A QoS may be measured by any known metric, a non-limiting example of which includes latency, wherein a maximum acceptable latency should not be exceeded. It should be noted that the QoS for client devices associated with radio subsystem 304 on channel 116 may be different that the QoS for client devices associated with radio subsystem 304 on channel 118. Further, in accordance with aspects of the present disclosure, network device 300 may change the time segments associated with the different bands in order to maximize the QoS for at least one of the client devices associated with radio subsystem 304 on channel 116 and for client devices associated with radio subsystem 304 on channel 118.

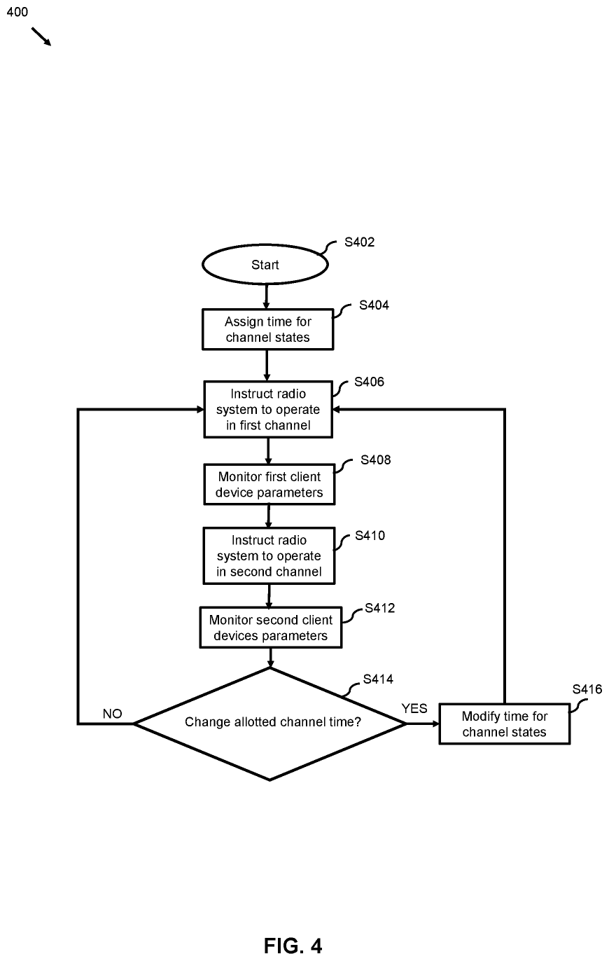

The switching of radio subsystem 304 between channels 116 and 118 will now be discussed with reference to FIG. 4.

FIG. 4 illustrates an algorithm 400 for allocating data between two bands on a single radio in accordance with aspects of the present disclosure.

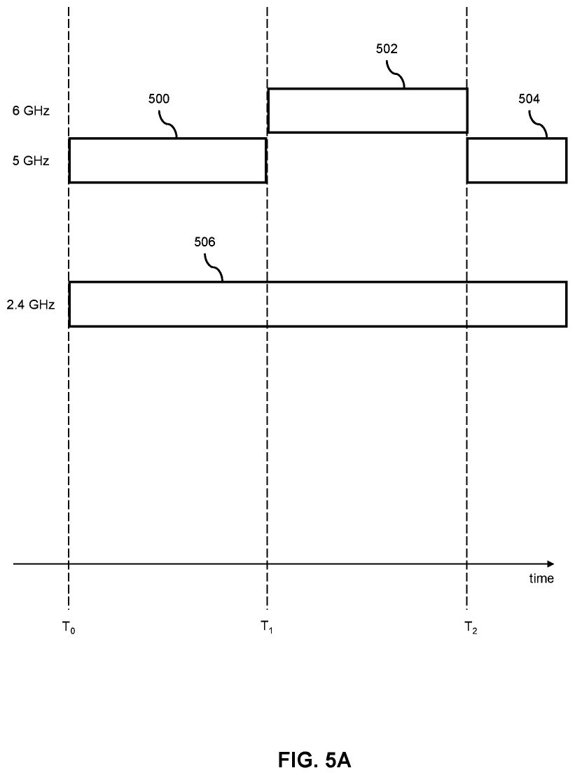

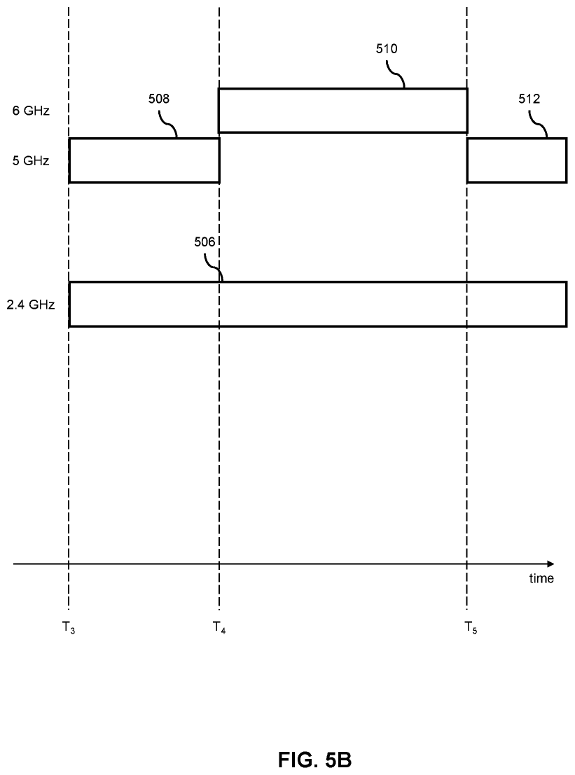

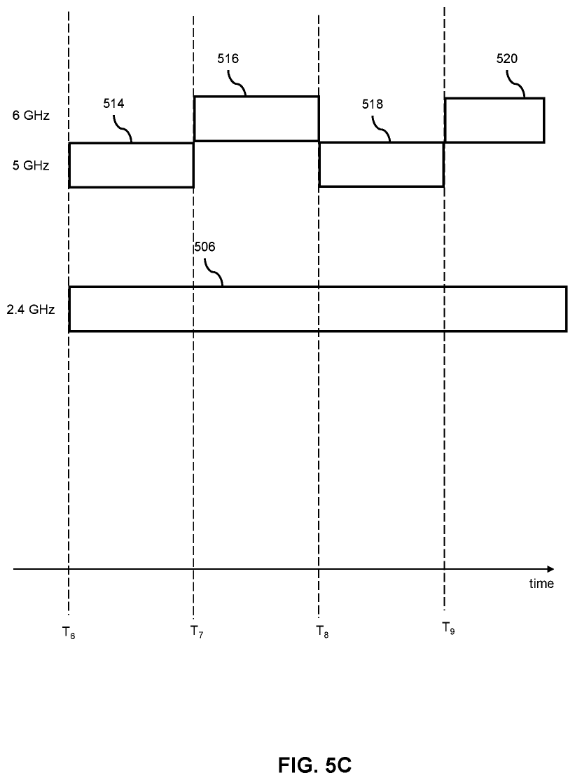

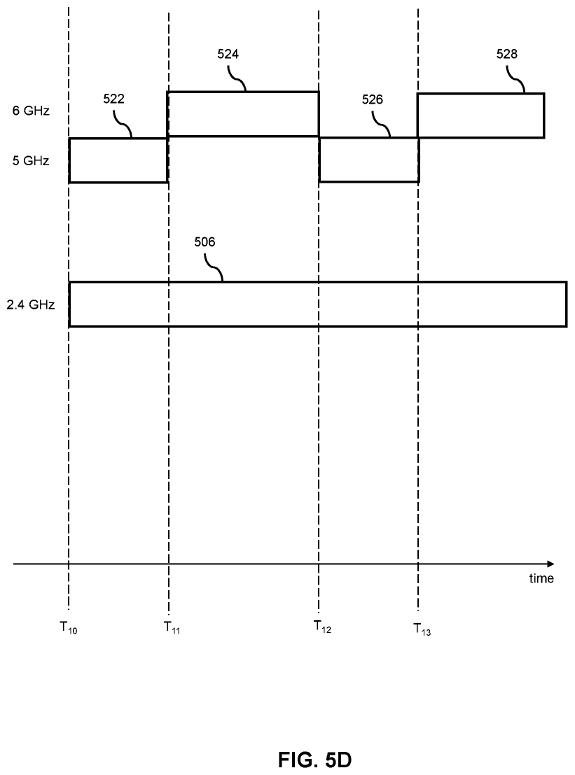

As shown in FIG. 4, algorithm 400 starts (S402) and times are assigned to channel states (S404). This will be described in greater detail with reference to FIGS. 5A-D.

FIG. 5A illustrates a sample embodiment of a time period for which data is transmitted over several radio frequency bands in an equal duty cycle, in accordance with aspects of the present disclosure.

FIG. 5A illustrates periods 500 and 502 during which data is transmitted over channels 116 and 118 using radio subsystem 304, channel 116 being within the 5 GHz band, and channel 118 being within the 6 GHz band. Periods 500 and 502 are interleaved, or multiplexed, in time in an equal duty cycle, or a 50/50 duty cycle. During period 506 data is transmitted over channel 120, or the 2.4 GHz band.

For example, with reference to FIG. 4, presume that user 102 has just purchased network device 300 and has powered it on. Client device 110 will associate with network device 300 via channel 120, client device 108 will associate with network device 300 via channel 118, and client device 106 will associate with network device 300 via channel 116. As shown in FIG. 5A, client device 110 will be able to transmit/receive data during period 506 over channel 120, or the 2.4 GHz band. Transmission/reception of data over channel 116 occurs during period 500, beginning at T₀ and ending at time T₁. Transmission/reception of data over channel 118 occurs during period 502, beginning at T₁ and ending at time T₂.

During the initial start-up of network device 300, there is a default setting for how network device 300 will equally allocate data between the 5 GHz band and the 6 GHz band. In this embodiment, network device 300 will transmit data between channels 116 and 118 in even intervals, or a 50/50 duty cycle. As shown in FIG. 5A, period 500 is equal in time to period 502.

This default setting may be used in cases wherein the number of client devices associated with network device in the 5 GHz band and the number of client devices associated with network device in the 6 GHz band are unknown. As such, the distribution of time for each of the bands to maintain a minimum acceptable QoS for client devices on both the 5 GHz band and the 6 GHz band is initially unknown. Similarly, this default setting may be used in cases wherein the amount of data transmitted and received by client devices associated with network device in the 5 GHz band and the amount of data transmitted and received by client devices associated with network device in the 6 GHz band are unknown. As such, the distribution of time for each of the bands to maintain a minimum acceptable QoS for client devices on both the 5 GHz band and the 6 GHz band is initially unknown.

However, the default allocation of time for the 5 GHz band the 6 GHz band may be different in other embodiments, as described in greater detail with reference to FIGS. 5B-D.

FIG. 5B illustrates another sample embodiment of a time period for which data is transmitted over several radio frequency bands in an unequal duty cycle, in accordance with aspects of the present disclosure.

FIG. 5B illustrates periods 508 and 510 during which data is transmitted over channels 116 and 118 using radio subsystem 304. Periods 508 and 510 are interleaved, or multiplexed, in time. However, in comparison to the embodiment discussed above with reference to FIG. 5A, in the embodiment illustrated in FIG. 5B, periods 508 and 510 are interleaved in time in an uneven duty cycle. In this non-limiting example, periods 508 and 510 are interleaved in a 60/40 duty cycle, wherein the 6 GHz band is allocated 60% of a period, whereas the 5 GHz band is allocated 40% of the period.

As shown in FIG. 5B, client device 110 will be able to transmit/receive data during period 506 over channel 120, or the 2.4 GHz band. Transmission/reception of data over channel 116 occurs during period 508, beginning at T₃ and ending at time T₄. Transmission/reception of data over channel 118 occurs during period 502, beginning at T₄ and ending at time T5.

During the initial start-up of network device 300, there is a default setting for how network device 300 will allocate data between the 5 GHz band and the 6 GHz band. In this embodiment, network device 300 will transmit data between channels 116 and 118 in uneven intervals. As shown in FIG. 5B, period 508 is shorter than period 510. In some embodiments, period 508 may be longer than period 510.

This default setting may be used in cases wherein the number of client devices associated with network device in the 5 GHz band are less than the number of client devices associated with network device in the 6 GHz band. As such, the distribution of time to maintain a minimum acceptable QoS for client devices on the 5 GHz band may be estimated to be less than the distribution of time to maintain a minimum acceptable QoS for client devices and the 6 GHz band. Similarly, this default setting may be used in cases wherein the amount of data transmitted and received by client devices associated with network device in the 5 GHz band is expected to be less than the amount of data transmitted and received by client devices associated with network device in the 6 GHz band. As such, the distribution of time to maintain a minimum acceptable QoS for client devices on the 5 GHz band may be estimated to be less than the distribution of time to maintain a minimum acceptable QoS for client devices and the 6 GHz band.

FIG. 5C illustrates another sample embodiment of a time period for which data is transmitted over several radio frequency bands in an equal duty cycle, in accordance with aspects of the present disclosure.

FIG. 5C illustrates periods 514, 516, and 518 during which data is transmitted over channels 116 and 118 using radio subsystem 304. Periods 514, 516, and 518 are interleaved, or multiplexed, in time. However, in comparison to the embodiment discussed above with reference to FIG. 5A, in the embodiment illustrated in FIG. 5C, periods 508 and 510 are much smaller.

As shown in FIG. 5C, client device 110 will be able to transmit and receive data during period 506 over channel 120, or the 2.4 GHz band. Transmission/reception of data over channel 116 occurs during period 514, beginning at T₆ and ending at time T₇. Transmission of data over channel 118 occurs during period 516, beginning at T₇ and ending at time T₈. Data is then again transmitted/received over channel 116 during period 518, beginning at T₈ and ending at time T₉.

As shown in FIG. 5C, periods 514, 516, and 518 are equal in length of time. However, network device 300 switches the transmission of data between channels 116 and 118 at a faster rate as compared to the embodiment discussed above with reference to FIG. 5A.

This default setting may be used in cases wherein a maximum latency for each of the bands may be estimated, and therefore a corresponding switching rate between the two bands may be estimated.

FIG. 5D illustrates another sample embodiment of a time period for which data is transmitted over several radio frequency bands, in accordance with aspects of the present disclosure, wherein the duty cycle is unequal as discussed above with reference to FIG. 5B, in combination with the switching rate being modified, as discussed above with reference to FIG. 5C.

FIG. 5D illustrates periods 522, 524, and 526 during which data is transmitted over channels 116 and 118 using radio subsystem 304. Periods 522, 524, and 526 are interleaved, or multiplexed, in time.

As shown in FIG. 5D, client device 110 will be able to transmit/receive data during period 506 over channel 120, or the 2.4 GHz band. Transmission/reception of data over channel 116 occurs during period 522, beginning at T₁₀ and ending at time T₁₁. Transmission/reception of data over channel 118 occurs during period 524, beginning at T₁₁ and ending at time T₁₂. Data is then again transmitted/received over channel 116 during period 526, beginning at T₁₂ and ending at time T₁₃.

In this embodiment, network device 300 will transmit data between channels 116 and 118 in uneven intervals that are shorter than those of FIG. 5A. As shown in FIG. 5D, periods 522 and 526 are equal in length of time, and both are less than period 524. When compared to FIG. 5B, network device 300 switches the transmission of data between channels 116 and 118 at a faster rate while still distributing unequal amounts of data to channels 116 and 118. In some embodiments, periods 522 and 526 would be greater than period 524.

As shown in FIGS. 5A-D, network device 300 is able to allocate data between the 5 GHz band and 6 GHz band in many different ways. Network device 300 can increase the time during which data is transmitted to one channel while decreasing the time during which data is transmitted to the other channel. Further, network device 300 can increase or decrease the duty cycle between the first channel and the second channel. Network device 300 may have a default setting for first time start-up, non-limiting examples of which may include: even data allocation between the 5 GHz band and the 6 GHz band with a short duty cycle; uneven data allocation between the 5 GHz band and the 6 GHz band with a short duty cycle; even data allocation between the 5 GHz band and the 6 GHz band with a long duty cycle; or uneven data allocation between the 5 GHz band and the 6 GHz band with a long duty cycle.

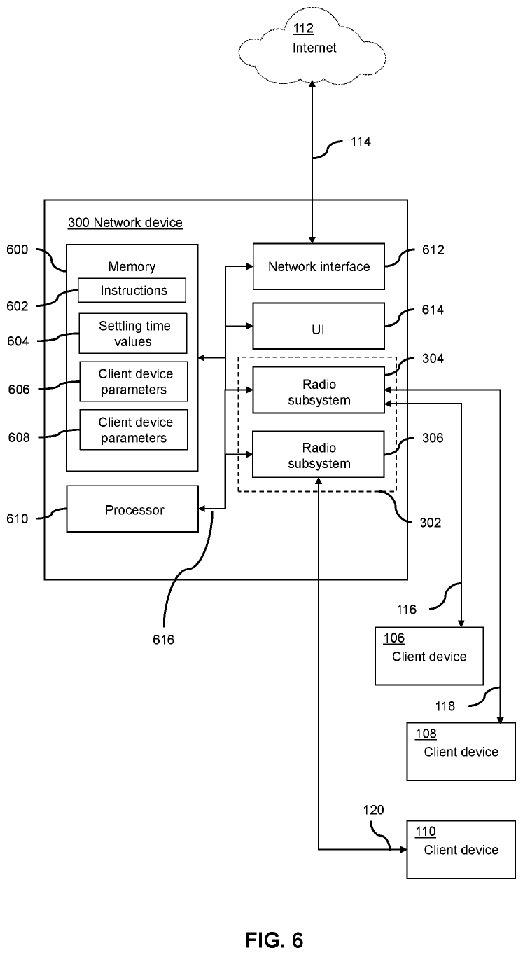

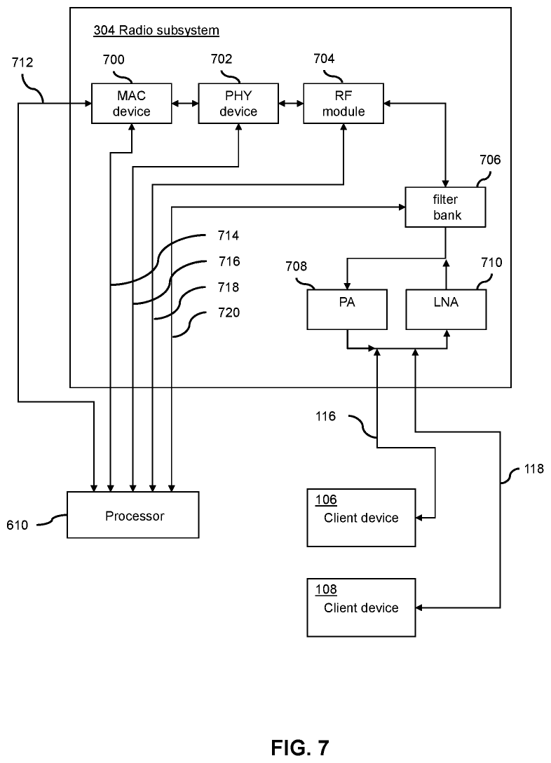

Now that Returning to FIG. 4, after times are assigned to channel states (S404), the radio system is instructed to operate in the first channel (S406). In particular, the initial allocation of time periods for the 5 GHz band and the 6 GHz band might not provide the minimum acceptable QoS for client devices associated with network device 300 on at least one of the 5 GHz band or the 6 GHz band. Alternatively, even if the initial allocation of time periods for the 5 GHz band and the 6 GHz band does provide the minimum acceptable QoS for client devices associated with network device 300 on both the 5 GHz band or the 6 GHz band, the QoS may be further maximized for client devices associated with network device 300 on at least one of the 5 GHz band and the 6 GHz band. This will be realized by first monitoring the data use on each band and then modifying the allocation accordingly, if needed. In this case, radio subsystem 304 is first instructed to operate in a first channel. This will be described in greater detail with reference to FIGS. 6 and 7.

FIG. 6 illustrates an exploded view of network device 300 that communicates with client devices 106, 108, and 110, in accordance with aspects of the present disclosure.

As shown in the figure, network device 300 contains a memory 600, a processor 610, a network interface 612, a user interface (UI) 614, and radio system 302. Radio system 302 contains radio subsystems 304 and 306. Memory 600, processor 610, network interface 612, UI 614, radio subsystem 304, and radio subsystem 306 are connected by bus 616. Memory 600 includes a plurality of memory sections including instructions 602, settling time values 604, and a plurality of client device parameters, a sample of which are indicated as client device parameters 606 and client device parameters 608.

Processor 610 may be any device or system capable of controlling general operations of network device 300 and includes, but is not limited to, central processing units (CPUs), hardware microprocessors, single-core processors, multi-core processors, field-programmable gate arrays (FPGAs), microcontrollers, application-specific integrated circuits (ASICs), digital signal processors (DSPs), or other similar processing devices capable of executing any type of instructions, algorithms, or software for controlling the operations and functions of network device 300.

Processor 610 is configured to execute instructions 602 stored in memory 600 to enable network device 300 to perform operations, as will be described in greater detail below.

Memory 600 may be any device or system capable of storing data and instructions used by network device 300 and includes, but is not limited to, random-access memory (RAM), dynamic random-access memory (DRAM), hard drives, solid-state drives, read-only memory (ROM), erasable programmable read-only memory (EPROM), electrically erasable programmable read-only memory (EEPROM), flash memory, embedded memory blocks in FPGAs, or any other various layers of memory hierarchy.

Settling time values 604 within memory 300 stores settling time values for radio subsystem 304 and radio subsystem 306, as will be described in greater detail below.

Client device parameters 606 within memory 300 stores data associated with predetermined monitored parameters of a client device that is associated with network device 300 via radio subsystem 304, as will be described in greater detail below.

Client device parameters 608 within memory 300 stores data associated with predetermined monitored parameters of another client device that is associated with network device 300 via radio subsystem 306, as will be described in greater detail below.

As will be described in greater detail below, memory 600 contains instructions 602 that when executed by processor 610, causes network device 300 to: determine an initial first portion of time for which radio system 302 should be configured to operate in the first channel state; determine an initial second portion of time for which radio system 302 should be configured to operate in the second channel state; instruct radio system 302 to operate in the first channel state for the initial first portion of time; monitor a first client device parameter associated with client device 106 during the first portion of time; instruct the radio system to operate in the second channel state for the initial second portion of time; monitor a second client device parameter associated with client device 108 during the second portion of time; modify the initial first portion of time based on at least one of the monitored first client device parameter and the monitored second client device parameter; generate the control signal to place radio system 302 in the first channel state for a subsequent portion of time based on the modified initial first portion of time; and transmit the control signal to radio system 302 via a control interface to place radio system 302 in the first channel state.

In some embodiments, as will be described in greater detail below, memory 600 contains instructions 602 that when executed by processor 610, additionally causes network device 300 to: modify the initial second portion of time based on at least one of the monitored first client device parameter and the monitored second client device parameter; generate a second control signal to place radio system 302 in the second channel state for a second subsequent portion of time based on the modified initial second portion of time; and transmit the second control signal to radio system 302 via a control interface to place radio system 302 in the second channel state.

In some of these embodiments, as will be described in greater detail below, memory 600 contains instructions 602 that when executed by processor 610, additionally causes network device 300 to generate the second control signal to modify a duty cycle between the first channel state and the second channel state.

In some of these embodiments, as will be described in greater detail below, memory 600 contains instructions 602 that when executed by processor 610, additionally causes network device 300 to generate the second control signal to modify a frequency of changing between the first channel state and the second channel state.

Radio system 302 is configured to operate in a first GHz band in the first state and to operate in a second GHz band in the second state. In some embodiments, as will be described in greater detail below, memory 600 contains instructions 602 that when executed by processor 610, cause network device 300 to operate in a third GHz band while operating in the first state or the second state.

Network interface 612 may be any device or system uses to establish and maintain channel 114. Network interface 612 can include one or more connectors, such as RF connectors, Ethernet connectors, wireless communications circuitry such as 5G transceivers, and one or more antennas. Network interface 612 transmits and receives data from Internet 112 by known methods, non-limiting examples of which include terrestrial antenna, satellite dish, wired cable, DSL, optical fiber, or 5G as discussed above.

UI 614 may be any device or system capable of presenting information and accepting user inputs on network device 300 and includes, but is not limited to, liquid crystal displays (LCDs), thin film transistor (TFT) displays, light-emitting diodes (LEDs), touch screens, buttons, microphones, and speakers.

In this example, processor 610, memory 600, network interface 612, UI 614, and radio system 302 are illustrated as individual devices of network device 300. However, in some embodiments, at least two of processor 610, memory 600, network interface 612, UI 614, and radio system 302 may be combined as a unitary device. Further, in some embodiments, at least one of processor 610, memory 600, network interface 612, UI 614, and radio system 302 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to processor 610 such that processor 610 may read information from, and write information to, the tangible computer-readable media. In the alternative, the tangible computer-readable media may be integral to processor 610. Processor 610 and the tangible computer-readable media may reside in an integrated circuit (IC), an ASIC, or large scale integrated circuit (LSI), system LSI, super LSI, or ultra LSI components that perform a part or all of the functions described herein. In the alternative, processor 610 and the tangible computer-readable media may reside as discrete components.

Example tangible computer-readable media may be also coupled to systems, non-limiting examples of which include a computer system/server, which is operational with numerous other general-purpose or special-purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Bus 616 may be any device or system that provides data communications between memory 600, processor 610, network interface 612, UI 614, and radio system 302. Bus 616 can be one or more of any of several types of bus structures, including a memory bus or a memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Instructions 602 operate the functions of network device 300, including communicating with Internet 112 and client devices 106, 108, and 110. Instructions 602, having a set (at least one) of program modules, may be stored in memory 600 by way of example, and not limitation, as well as an operating system, one or more application programs, other program modules, and program data. Each of the operating systems, one or more application programs, other program modules, and program data or some combination thereof, may include an implementation of a networking environment. The program modules generally carry out the functions and/or methodologies of various embodiments of the application as described herein.

Client device parameters 606 and client device parameters 608 describe the communications requirements of client device 106 and 108, respectively. In this non-limiting example, client device parameters 606 includes modulation and coding schemes (MCS), bandwidth requirements, and latency requirements of client device 106. Similarly, client device parameters 608 includes MCS, bandwidth requirements, and latency requirements of client device 108.

Settling time values 604 characterize time-domain behavior of radio subsystem 304 when switching from one channel state to another. This is described in great detail in U.S. application Ser. No. 17/831,762, filed on Jun. 3, 2022 which claims priority to U.S. Application Ser. No. 63/209,617, filed on Jun. 11, 2021, the entire disclosure of which is incorporated herein by reference. This will be discussed in further detail with reference to FIG. 7.

FIG. 7 illustrates radio subsystem 304, in accordance with aspects of the present disclosure.

As shown in the figure, radio subsystem 304 contains a MAC device 700, a PHY device 702, an RF module 704, a filter bank 706, a power amplifier (PA) 708, and a low noise amplifier (LNA) 710. MAC device 700 is controlled by processor 610 via a MAC device control interface 714. PHY device 702 is controlled by processor 610 via a PHY device control interface 716. RF module 704 is controlled by processor 610 via an RF module control interface 718. Filter bank 706 is controlled by processor 610 via a filter bank control interface 720. Processor 610 sends data to and receives data from radio subsystem 304 on line 712. It should be noted any one of MAC device control interface 714, PHY device control interface 716, RF module control interface 718, and filter bank control interface 720 may be a wired signal line or a software interface that is configured to transmit information from processor 810 to the respective MAC device 700, PHY device 702, RF module 704 and filter bank 706.

MAC device 700 may be any device or system configured to manage the link layer of a communications protocol stack. In this non-limiting example, MAC device 700 maintains a list of network names, or Service Set Identifiers (SSIDs), configured on a Wi-Fi band. MAC device 700 also maintains a list of devices, or stations (STAs), configured on each SSID. MAC device control interface 714 controls whether MAC device 700 is operating on a 5 GHz band or a 6 GHz band.

PHY device 702 may be any device or system configured to code and modulate digital data onto a communications medium. In this non-limiting example, PHY device 702 transforms digital data into an analog baseband signal when transmitting and transforms an analog baseband signal into digital data when receiving. PHY device control interface 716 controls whether PHY device 702 is operating on a 5 GHz band or a 6 GHz band.

RF module 704 may be any device or system that transforms an analog baseband signal to and from wireless communications bands. In this non-limiting example, RF module 704 up-converts a baseband signal provided by PHY device 702 into a radio frequency signal at 5 or 6 GHz when transmitting; and down-converts a radio frequency signal from 5 or 6 GHz to baseband when receiving. RF module control interface 718 controls whether RF module 704 is operating on a 5 GHz band or a 6 GHz band.

Filter bank 706 may be any device or system that attenuates certain frequency ranges to improve radio communications performance. In this non-limiting example, filter bank control interface 720 controls whether filter bank 706 operates as a 5 GHz bandpass filter or as a 6 GHz bandpass filter.

PA 708 and LNA 710 may be any devices or systems that amplify a radio signal. In this non-limiting example, PA 708 amplifies the power of the Wi-Fi signal being transmitted by radio subsystem 304; LNA 710 amplifies the power of the Wi-Fi signal being received by radio sub system 304.

Though MAC device 700 and PHY device 702 are illustrated as separate components, it is contemplated that MAC device 700 and PHY device 702 may be combined into a single device. Similarly, though RF module 704, filter bank 706, PA 708, and LNA 710 are illustrated as separate components, it is contemplated that two or more of RF module 704, filter bank 706, PA 708, and LNA 710 may be combined into a single device. Furthermore, though filter bank 706 is illustrated as disposed between RF module 704 and PA 708 and LNA 710, it is contemplated that the order of components may differ in other implementations. In another non-limiting example, PA 708 and LNA 710 are disposed between RF module 704 and filter bank 706.

Though MAC device control interface 714, PHY device control interface 716, RF module control interface 718, and filter bank control interface 720 are illustrated as separate lines, it is contemplated that two or more of MAC device control interface 714, PHY device control interface 716, RF module control interface 718, and filter bank control interface 720 may be combined, or incorporated into other components such as bus 616, as reference in FIG. 6.

Radio subsystem 304 can be switched to operate in one channel state or another. In this non-limiting example, radio subsystem 304 can be switched to operate in a 5 GHz band or in a 6 GHz band.

In operation, and with reference to FIG. 6, processor 610 executes instructions 602 stored on memory 600 causing a MAC device control signal to be sent on MAC device control interface 714, a PHY device control signal to be sent on PHY device control interface 716, an RF module control signal to be sent on RF module control interface 718, and a filter bank control signal to be sent on filter bank control interface 720 to place radio subsystem 304 into one channel state or another.

In operation, switching channel states does not occur instantaneously; in this non-limiting example, MAC device 700 has to exchange one set of SSIDs and STAs for another; PHY device 702 has to be configured with modulation and coding schemes of the new channel state; and RF module 704 and filter bank 706 must allow transient signals to decay and stabilize. This time interval is characteristic of each channel state and radio subsystem components and is described by settling time values 604, which is stored in memory 600.

Returning to FIG. 7, processor 610 sends a MAC device control signal on MAC device control interface 714, a PHY device control signal on PHY device control interface 716, an RF module control signal on RF module control interface 718, and a filter bank control signal on filter bank control interface 720 to place radio subsystem 304 in a state that supports the first Wi-Fi band. In operation and referring to FIG. 5A, the MAC device control signal, the PHY device control signal, the RF module control signal, and the RF module control signal are sent at time T₀. Processor 610 then transmits data on line 712 to radio subsystem 304, which transmits data within period 500 on channel 116 to client device 106. In another non-limiting example, with reference to FIGS. 5B-D, the MAC device control signal, the PHY device control signal, the RF module control signal, and the RF module control signal are sent at different times slightly before or after time T₀. Processor 610 would then transmit data on line 712 to radio subsystem 304, which transmits data within a 5 GHz period on channel 116 to client device 106.

Returning to FIG. 4, after the radio system is instructed to operate in the first channel (S406), the first client device parameters are monitored (S408). For example, presume that radio subsystem 304 has been placed in a state that supports the 5 GHz band, allowing network device 300 to transmit data over channel 116, as referenced in FIG. 6. Processor 610 will execute instructions stored on memory 600 causing network device 300 to monitor a multitude of parameters associated with client device 106. Non-limiting examples of client device parameters include the total number of packets from client device 106, the number of different application packets from client device 106, and a combination thereof.

It should be noted that network device 300 may support multiple client devices on each of the 5 GHz band and 6 GHz band. However, in order to simplify the discussion, in this non-limiting example, only client device 106 is associated with network device 300 within the 5 GHz band. In this light, in accordance with aspects of the present disclosure, processor 610 may execute instructions stored on memory 600 to cause network device 300 to monitor: the total number of packets from all client devices within the 5 GHz band; the number of different application packets from all client devices within the 5 GHz band; the number of client devices associated with network device 300 with the 5 GHz band, and combinations thereof.

As shown in FIG. 6, processor 610 then stores the values of the monitored parameters associated with client device 106 within the 5 GHz band in client device parameters 606 of memory 600.

Returning to FIG. 4, after the first client device parameters are monitored (S408), the radio system is instructed to operate in the second channel (S410). In particular, now that the parameters of the first band, which in this non-limiting example embodiment is the 5 GHz band, the parameters of the other band should be monitored in order to determine whether the minimum acceptable QoS for both bands are being met. For example, as referenced in FIG. 7, after monitoring parameters associated with client device 106, processor 610 sends a MAC device control signal on MAC device control interface 714, a PHY device control signal on PHY device control interface 716, an RF module control signal on RF module control interface 718, and a filter bank control signal on filter bank control interface 720 to place radio subsystem 304 in a state that supports the second Wi-Fi band. In operation and referring to FIG. 5A, the MAC device control signal, the PHY device control signal, the RF module control signal, and the RF module control signal are sent at time T₁. Processor 610 then transmits data on line 712 to radio subsystem 304, which transmits data within period 502 on channel 118 to client device 108. In another non-limiting example, with reference to FIGS. 5B-D, the MAC device control signal, the PHY device control signal, the RF module control signal, and the RF module control signal are sent at different times slightly before or after time T₁. Processor 610 would then transmit data on line 712 to radio subsystem 304, which transmits data within a 6 GHz period on channel 118 to client device 108.

Returning to FIG. 4, after the radio system is instructed to operate in the second channel (S410), the second client device parameters are monitored (S412). For example, presume that radio subsystem 304 has been placed in a state that supports the 6 GHz band, allowing network device 300 to transmit data over channel 118. Processor 610 will execute instructions stored on memory 600 causing network device 300 to monitor a multitude of parameters associated with client device 108, in a manner similar to that discussed above with reference to the 5 GHz band (see S408).

As shown in FIG. 6, processor 610 then stores the values of the monitored parameters associated with client device 108 within the 6 GHz band in client device parameters 608 of memory 600.

Returning to FIG. 4, after the second client device parameters are monitored (S412), it is determined if the allotted channel times should be changed (S414). For example, after monitoring the client device parameters associated with client device 106, processor 610 will execute instructions stored on memory 600 causing network device 300 to analyze the client device parameters associated with client device 106 and client device 108. Network device 300 is configured to analyze the client device parameters of connected devices in order to determine how transmitted data is allocated between the 5 GHz and 6 GHz band.

Returning to FIG. 6, in some non-limiting example embodiments, memory 600 may have stored therein, predetermined acceptable threshold values related to the monitored parameters. Processor 610 may then compare the predetermined acceptable threshold values with the monitored client device parameter values stored in each of client device parameters 606 of memory 600 and client device parameters 608 of memory 600.

For example, in some example embodiments, the total number of packets from client device 106 within the 5 GHz band may be compared with a predetermined threshold value, TV_{TP5}, of a total number of packets for the 5 GHz band. If the total number of packets from client device 106 within the 5 GHz band is greater than TV_{TP5}, then the time allotment for client device 106 within the 5 GHz band might need to be increased. Similarly, total number of packets from client device 108 within the 6 GHz band may be compared with a predetermined threshold value, TV_{TP6}, of a total number of packets for the 6 GHz band. If the total number of packets from client device 108 within the 6 GHz band is greater than TV_{TP6}, then the time allotment for client device 108 within the 6 GHz band might need to be increased. In some embodiments, TV_{TP5} may be the same of TV_{TP6}, whereas in other embodiments, TV_{TP5} may not be the same as TV_{TP6}.

In some example embodiments, the number of different application packets from client device 106 within the 5 GHz band may be compared with a predetermined threshold value, TV_{AP5}, of a total number of packets for the 5 GHz band. If the number of different application packets from client device 106 within the 5 GHz band is greater than TV_{AP5}, then the time allotment for client device 106 within the 5 GHz band might need to be increased. Similarly, the number of different application packets from client device 108 within the 6 GHz band may be compared with a predetermined threshold value, TV_{AP6}, of a total number of packets for the 6 GHz band. If the number of different application packets from client device 108 within the 6 GHz band is greater than TV_{AP6}, then the time allotment for client device 108 within the 6 GHz band might need to be increased. In some embodiments, TV_{AP5} may be the same of TV_{AP6}, whereas in other embodiments, TV_{AP5} may not be the same as TV_{AP6}.

In some example embodiments, the number of client devices within the 5 GHz band may be compared with a predetermined threshold value, TV_{CD5}, of a total number of client devices for the 5 GHz band. If the number of client devices using the 5 GHz band is greater than TV_{CD5}, then the time allotment for the 5 GHz band might need to be increased. Similarly, the number of client devices within the 6 GHz band may be compared with a predetermined threshold value, TV_{CD6}, of a total number of client devices for the 6 GHz band. If the number of client devices using the 6 GHz band is greater than TV_{CD6}, then the time allotment for the 6 GHz band might need to be increased. In some embodiments, TV_{CD5} may be the same of TV_{CD6}, whereas in other embodiments, TV_{CD5} may not be the same as TV_{CD6}.

In some embodiments, processor may compare the monitored parameters of client devices using the 5 GHz band with the parameters of client devices using the 6 GHz band as opposed to comparing the monitored parameters of each with a respective threshold.

For example, in some example embodiments, the total number of packets from client device 106 within the 5 GHz band may be compared with the total number of packets from client device 108 within the 6 GHz band. If the total number of packets from client device 106 within the 5 GHz band is less than the total number of packets from client device 108 within the 6 GHz band, then the time allotment for the 6 GHz band might need to be increased. Conversely, if the total number of packets from client device 106 within the 5 GHz band is greater than the total number of packets from client device 108 within the 6 GHz band, then the time allotment for the 5 GHz band might need to be increased.

Further, in some example embodiments, the number of different application packets from client device 106 within the 5 GHz band may be compared with the number of different application packets from client device 108 within the 6 GHz band. If the number of different application packets from client device 106 within the 5 GHz band is less than the number of application packets from client device 108 within the 6 GHz band, then the time allotment for the 6 GHz band might need to be increased. Conversely, if the number of different application packets from client device 106 within the 5 GHz band is greater than the number of application packets from client device 108 within the 6 GHz band, then the time allotment for the 5 GHz band might need to be increased.

Still further, in some example embodiments, the number of client devices within the 5 GHz band may be compared with the number of client devices within the 6 GHz band. If the number of client devices using the 5 GHz band is less than the number of client devices using the 6 GHz band, then the time allotment for the 6 GHz band might need to be increased. Conversely, if the number of client devices using the 5 GHz band is greater than the number of client devices using the 6 GHz band, then the time allotment for the 5 GHz band might need to be increased.

Returning to FIG. 4, if it is determined that the allotted channel times should be changed (Y at S414), then the time for the channel states is modified (S416). For example, with reference to FIG. 5A, presume that the default setting of network device 300 is to allocate data evenly between both channel 116 and 118; however, with reference to FIG. 5B, presume that network device 300 has determined that it would be optimal to allocate more data to channel 118 after analyzing the client device parameters of client devices 116 and 118. Client device 108, associated with channel 118, is being used more than client device 116, meaning that client device 118 could use more data. Processor 610 will execute instructions stored on memory 600 to cause network device 300 to modify the length of the channel periods to resemble periods 508 and 510.

Network device 300 may modify the length of the channel periods in any manner as discussed above, with reference to FIGS. 5B-D.

Returning to FIG. 4, after the time for the channel states is modified (S416), then the radio system is again instructed to operate in the first channel (Return to S406). For example, after network device 300 has modified the lengths of the channel periods, network device 300 will repeat the process causing network device 300 to allocate data to channel 516. Network device 300 will continue to monitor and analyze the client device parameters of client devices 106 and 108 in order, constantly updating the allocation of data between channels 116 and 118.

Returning to FIG. 4, if it is determined that the allotted channel times should not be changed (N at S414), then the radio system is again instructed to operate in the first channel (Return to S406). For example, with reference to FIG. 5A, presume that the default setting of network device 300 is to allocate data evenly between both channel 116 and 118. Network device 300 then determines that data allocation between channels 116 and 118 is optimal as is. As such, network device 300 will repeat the process until it determines that there is a need to change the data allocation between channels 116 and 118.

For purposes of the discussion, only three client devices were used in reference to FIGS. 1-7. However, in some embodiments, communication system 100 may include more than three client devices.

Today's home and work networks contain many devices capable of connecting to the Internet via Wi-Fi. The standard for network devices in the networks is to have a 2.4 GHz band, and a 5 GHz band. With the addition of 6 GHz bands to the market, many network devices are adding in radios to provide 6 GHz band support. However, few client devices are able to operate on 6 GHz bands. Adding a third radio for 6 GHz band support to network devices costs more for manufacturers and consumers, and many consumers will get no use out of the extra radio.

In accordance with the present disclosure, a network device will have a plurality of radio subsystems, wherein one may be dedicated to operate on one band, for example the 2.4 GHz band, and another radio subsystem may switch between two bands, for example between a 5 GHz and 6 GHz bands. The network device will transmit data to client devices on the 5 GHz band, and then switch and repeat the process with the 6 GHz band. The network device will analyze client devices connected to the dual-band radio subsystem, and constantly update the length of the 5 GHz transmission period and the 6 GHz transmission period. Cutting out an additional radio from the network device will cut costs for manufacturers and create a cheaper product for consumers.

The operations disclosed herein may constitute algorithms that can be affected by software, applications (apps, or mobile apps), or computer programs. The software, applications, computer programs can be stored on a non-transitory computer-readable medium for causing a computer, such as the one or more processors, to execute the operations described herein and shown in the drawing figures.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A network device for use with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel, said client device comprising:
a memory;
a radio system controllably configured to operate in a first channel state or a second channel state, the first channel state enabling transmission of the first client device reception data on the first channel and reception of the first client device transmission data on the first channel, the second channel state enabling transmission of the second client device reception data on the second channel and reception of the second client device transmission data on the second channel;
a control interface arranged to provide a control signal to said radio system so as to place said radio system in either the first channel state or the second channel state; and
a processor configured to execute instructions stored on said memory to cause said network device to:
determine an initial first portion of time for which said radio system should be configured to operate in the first channel state;
determine an initial second portion of time for which said radio system should be configured to operate in the second channel state;
instruct said radio system to operate in the first channel state for the initial first portion of time;
monitor a first client device parameter associated with the first client device during the first portion of time;
instruct said radio system to operate in the second channel state for the initial second portion of time;
monitor a second client device parameter associated with the second client device during the second portion of time;
modify the initial first portion of time based on at least one of the monitored first client device parameter and the monitored second client device parameter;
generate the control signal to place said radio system in the first channel state for a subsequent portion of time based on the modified initial first portion of time; and
transmit the control signal to said radio system via said control interface to place said radio system in the first channel state.

2. The network device of claim 1, wherein said processor is configured to execute instructions stored on said memory to additionally cause said network device to:
modify the initial second portion of time based on at least one of the monitored first client device parameter and the monitored second client device parameter;
generate a second control signal to place said radio system in the second channel state for a second subsequent portion of time based on the modified initial second portion of time; and
transmit the second control signal to said radio system via said control interface to place said radio system in the second channel state.

3. The network device of claim 2, wherein said processor is configured to execute instructions stored on said memory to additionally cause said network device to generate the second control signal to modify a duty cycle between the first channel state and the second channel state.

4. The network device of claim 2, wherein said processor is configured to execute instructions stored on said memory to additionally cause said network device to generate the second control signal to modify a frequency of changing between the first channel state and the second channel state.

5. The network device of claim 1, wherein said radio system is configured to operate in a first GHz band in the first state and to operate in a second GHz band in the second state.

6. The network device of claim 5, wherein said radio system is further configured to operate in a third GHz band while operating in the first state or the second state.

7. A method of using a network device with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel, said method comprising:
determining, via a processor configured to execute instructions stored on a memory, an initial first portion of time for which the radio system should be configured to operate in the first channel state;
determining, via the processor, an initial second portion of time for which the radio system should be configured to operate in the second channel state;
instructing, via the processor, the radio system to operate in the first channel state for the initial first portion of time;
monitoring, via the processor, a first client device parameter associated with the first client device during the initial first portion of time;
instructing, via the processor, the radio system to operate in the second channel state for the initial second portion of time;
monitoring, via the processor, a second client device parameter associated with the second client device during the initial second portion of time;
modifying, via the processor, the initial first portion of time based on at least one of the monitored first client device parameter and the monitored second client device parameter;
generating, via the processor, the control signal to place the radio system in the first channel state for a subsequent portion of time based on the modified initial first portion of time; and
transmitting, via the processor, the control signal to the radio system via the control interface to place the radio system in the first channel state.

8. The method of claim 7, further comprising:
modifying, via the processor, the initial second portion of time based on at least one of the monitored first client device parameter and the monitored second client device parameter;
generating, via the processor, a second control signal to place the radio system in the second channel state for a second subsequent portion of time based on the modified initial second portion of time; and
transmitting, via the processor, the second control signal to the radio system via the control interface to place the radio system in the second channel state.

9. The method of claim 8, further comprising generating, via the processor, the second control signal to modify a duty cycle between the first channel state and the second channel state.

10. The method of claim 8, further comprising generating, via the processor, the second control signal to modify a frequency of changing between the first channel state and the second channel state.

11. The method of claim 7, wherein the radio system is configured to operate in a first GHz band in the first state and to operate in a second GHz band in the second state.

12. The method of claim 11, further comprising operating the radio system in a third GHz band while operating in the first state or the second state.

13. A non-transitory, computer-readable media having computer-readable instructions stored thereon, the computer-readable instructions being capable of being read by a network device for use with a first client device and a second client device, the first client device being configured to transmit first client device transmission data on a first channel and to receive first client device reception data on the first channel, the second client device being configured to transmit second client device transmission data on a second channel and to receive second client device reception data on the second channel, the first channel being different from the second channel, wherein the computer-readable instructions are capable of instructing the client device to perform the method comprising:
determining, via a processor configured to execute instructions stored on a memory, an initial first portion of time for which the radio system should be configured to operate in the first channel state;
determining, via the processor, an initial second portion of time for which the radio system should be configured to operate in the second channel state;
instructing, via the processor, the radio system to operate in the first channel state for the initial first portion of time;
monitoring, via the processor, a first client device parameter associated with the first client device during the initial first portion of time;
instructing, via the processor, the radio system to operate in the second channel state for the initial second portion of time;
monitoring, via the processor, a second client device parameter associated with the second client device during the initial second portion of time;
modifying, via the processor, the initial first portion of time based on at least one of the monitored first client device parameter and the monitored second client device parameter;
generating, via the processor, the control signal to place the radio system in the first channel state for a subsequent portion of time based on the modified initial first portion of time; and
transmitting, via the processor, the control signal to the radio system via the control interface to place the radio system in the first channel state.

14. The non-transitory, computer-readable media of claim 13, wherein the computer-readable instructions are capable of instructing the client device to perform the method further comprising:
modifying, via the processor, the initial second portion of time based on at least one of the monitored first client device parameter and the monitored second client device parameter;
generating, via the processor, a second control signal to place the radio system in the second channel state for a second subsequent portion of time based on the modified initial second portion of time; and
transmitting, via the processor, the second control signal to the radio system via the control interface to place the radio system in the second channel state.

15. The non-transitory, computer-readable media of claim 14, wherein the computer-readable instructions are capable of instructing the client device to perform the method further comprising generating, via the processor, the second control signal to modify a duty cycle between the first channel state and the second channel state.

16. The non-transitory, computer-readable media of claim 14, wherein the computer-readable instructions are capable of instructing the client device to perform the method further comprising generating, via the processor, the second control signal to modify a frequency of changing between the first channel state and the second channel state.

17. The non-transitory, computer-readable media of claim 13, wherein the computer-readable instructions are capable of instructing the client device to perform the method wherein the radio system is configured to operate in a first GHz band in the first state and to operate in a second GHz band in the second state.

18. The non-transitory, computer-readable media of claim 17, wherein the computer-readable instructions are capable of instructing the client device to perform the method further comprising operating the radio system in a third GHz band while operating in the first state or the second state.
